(19) United States
(12) Patent Application Publication
(10) Pub. No.: US 2024/0069456 A1
(43) Pub. Date: Feb. 29, 2024

(54) DEVELOPER, DEVELOPER SET, AND IMAGE FORMING APPARATUS

(71) Applicant: KYOCERA Document Solutions Inc., Osaka (JP)

(72) Inventors: Kohei TERASAKI, Osaka-shi (JP); Norio KUBO, Osaka-shi (JP); Yuji TOYOTA, Osaka-shi (JP); Akira MATAYOSHI, Osaka-shi (JP)

(73) Assignee: KYOCERA Document Solutions Inc., Osaka (JP)

(21) Appl. No.: 18/458,982

(22) Filed: Aug. 30, 2023

(30) Foreign Application Priority Data
Aug. 31, 2022 (JP) 2022-138126

(51) Int. Cl. G03G 9/083; G03G 9/09; G03G 9/113; G03G 15/08

(52) U.S. Cl. CPC G03G 9/0833; G03G 9/0904; G03G 9/1139; G03G 15/0867

(57) ABSTRACT

Toner particles in a developer include first strontium titanate particles attached to the surface of each toner mother particle thereof. The first strontium titanate particles have a content ratio of 0.3 to 0.9 parts by mass to 100.0 parts by mass of the toner mother particles. In the developer, coat layers of carrier mother particles of first carrier particles contain barium titanate particles and a coating resin including silicone resin. The barium titanate particles have a content ratio of 2 to 47 parts by mass to 100 parts by mass of the coating resin. Second strontium titanate particles attached to the surfaces of the carrier mother particles have a diameter of 15 to 85 nm.

### INCORPORATION BY REFERENCE

The present application claims priority wider 35 U.S.C. § 119 to Japanese Patent Application No. 2022-138126, filed on Aug. 31, 2022. The contents of this application are incorporated herein by reference in their entirety.

### BACKGROUND

The present disclosure relates to a developer, a developer set, and an image forming apparatus.

Image forming apparatuses that form images with a toner are required to form images with less fogging. An electrophotographic developer for example containing a toner and a carrier is proposed for the purpose of inhibiting toner attachment to a non-image area of paper. The carrier is formed with carrier cores coated with resin layers. In a process prior to mixing with the toner, at least one additive for use in the toner is pre-added to and mixed with the carrier.

### SUMMARY

A developer according to an aspect of the present disclosure includes a toner containing toner particles and a first carrier containing first carrier particles. The toner particles each include a toner mother particle and first strontium titanate particles attached to a surface of the toner mother particle. The first strontium titanate particles have content ratio of at least 0.3 parts by mass and no greater than 0.9 parts by mass to 100.0 parts by mass of the toner mother particles. The first carrier particles each include a carrier mother particle and second strontium titanate particles attached to a surface of the carrier mother particle. The carrier mother particles each include a carrier core and a coat layer covering a surface of the carrier core. The coat layers contain a coating resin and barium titanate particles. The coating resin includes silicone resin. The barium titanate particles have a content ratio of at least 2 parts by mass and no greater than 47 parts by mass to 100 parts by mass of the coaling resin. The second strontium titanate particles have a number average primary particle diameter of at least 15 nm and no greater than 85 nm. The second strontium titanate particles have a content ratio of at least 0.02 parts by mass and no greater than 0.06 parts by mass to 100.00 parts by mass of the carder mother particles.

A developer set according to another aspect of the present disclosure includes an initial developer and a replenishment developer. The initial developer is the aforementioned developer.

An image forming apparatus according to another aspect of the present disclosure includes a developer and a development device that develops an electrostatic latent image with the developer. The developer includes an initial developer. The development device includes an accommodation section that accommodates the initial developer. The initial developer is the aforementioned developer.

### BRIEF DESCRIPTION OF THE DRAWINGS

FIG. 1 is a cross-sectional view of examples of a toner particle and a carder particle in a developer according to a first embodiment of the present disclosure.

FIG. 2 is a cross-sectional view of examples of a toner particle and a carder particle in a second developer, wherein the second developer is an example of a replenishment developer included in a developer set according to a second embodiment of the present disclosure.

FIG. 3 is a diagram illustrating an example of an image forming apparatus according to a third embodiment of the present disclosure.

FIG. 4 is a diagram illustrating an example of a development device and its surroundings in the image forming apparatus illustrated in FIG. 3.

### DETAILED DESCRIPTION

The meaning of the terms and measurement methods that are used in the present specification are described first. A toner is a collection (e.g., a powder) of toner particles. An external additive is a collection e.g., a powder) of external additive particles. A carrier is a collection (e.g., a powder) of carrier particles. Values indicating for example shape or property of a powder (specific examples include a powder of toner particles, a powder of external additive particles, or a powder of carder particles) each are a number average value of values as measured with respect to a suitable number of particles selected from the powder unless otherwise stated. The “main component” of a material means a component most abundant in the material in terms of mass unless otherwise stated. In the following description, the term “-based” may be appended to the name of a chemical compound to form a generic name encompassing both the chemical compound itself and derivatives thereof. When the term “-based” is appended to the name of a chemical compound to represent the name of a polymer, the term indicates that a repeating unit of the polymer originates from the chemical compound or a derivative thereof. The term “(meth)actyl” is used as a generic term for both seryl and methacryl. One type of each component described in the present specification may be used independently, or two or more types of the component may be used in combination.

Values for saturation magnetization are values as measured using a high sensitivity vibrating sample magnetometer (e.g., “VSM-P7”, product of TOO INDUSTRY CO., LTD.) under a condition of an external magnetic field of 3000 (unit: Oe) unless otherwise stated. The volume median diameter (D₅₀) of a powder is a median diameter of the powder as measured using a laser diffraction/scattering type particle size distribution analyzer (e.g., “LA-950”, product of HORIBA, Ltd.) unless otherwise stated. Unless otherwise stated, the number average particle diameter of a powder is a number average value of equivalent circle diameters (Heywood diameters: diameters of circles having the same areas as projected areas of the primary particles) of primary particles of the powder as measured using a scanning electron microscope. The number average primary particle diameter is a number average value of equivalent circle diameters of 100 primary particles, for example. Values for softening point (Tm) are values as measured using a capillary rheometer “CFT-500D”, product of Shimadzu Corporation) unless otherwise stated. On an S-shaped curve (vertical axis: temperature, horizontal axis: stroke) as plotted using the capillary rheometer, the softening point (Tm) corresponds to the temperature corresponding to a stroke value of “(base line stroke value f maximum stroke value)/2”. Values for melting point (Mp) each are a temperature at a maximum endothermic peak on an endothermic curve (vertical axis: heat flow (DSC signal), horizontal axis: temperature) as plotted using a differential scanning calorimeter (e.g., “DSC-6220”, product of Seiko Instruments Inc.) unless otherwise state. The endothermic peak appears due to melting of the crystallization site. Values for glass transition point (Tg) are values as measured in accordance with “the Japanese Industrial Standards (JIS) K7121-2012” using a differential scanning calorimeter (e.g., “DSC-6220”, product of Seiko Instruments Inc.) unless otherwise stated. The glass transition point corresponds to the temperature corresponding to a point of inflection (specifically, an intersection point of an extrapolated baseline and an extrapolated falling line) caused by glass transition on a heat absorption curve (vertical axis: heat flow (DSC signal), horizontal axis: temperature) plotted using the differential scanning calorimeter. Values for acid value and hydroxyl value are values as measured in accordance with “the Japanese Industrial Standards (JIS) K0070-1992” unless otherwise stated. Values for mass average molecular weight (Mw) are values as measured using gel permeation chromatography unless otherwise state. Values for amount of charge (unit: μC/g) are values as measured using a compact suction-type charge measuring device (e.g., MODEL 212HS”, product of TREK, INC.) in an environment at a temperature of 25° C. and a relative humidity of 50% unless otherwise stated. The meaning of the terms and the measurement methods that are used in the present specification have been explained so far.

### First Embodiment: Developer

The following describes a developer according to a first embodiment of the present disclosure. In the following, the “developer according to the first embodiment” may be also referred to below as a “first developer”. The first developer is a two-component developer.

The first developer contains a toner and a first carrier. The toner contains toner particles. The first carrier contains first carrier particles. The toner particles each include a toner mother particle and first strontium titanate particles. The first strontium titanate particles are attached to the surface of the toner mother particle. The first strontium titanate particles have a content ratio of at least 0.3 parts by mass and no greater than 0.9 parts by mass to 100.0 parts by mass of the toner mother particles. The first carrier particles each include a carrier mother particle and second strontium titanate particles. The second strontium titanate particles are attached to the surface of the toner mother particle. The carrier mother particles each include a carrier core and a coat layer. The coat layer covers the surface of the carrier core. The coat layers contain a coating resin and barium titanate particles. The coating resin includes silicone resin. The barium titanate particles have a content ratio of at least 2 parts by mass and no greater than 47 parts by mass to 100 parts by mass of the coating resin. The second strontium titanate particles have a number average primary particle diameter of at least 1.5 nm and no greater than 85 nm. The second strontium titanate particles have a content ratio of at least 0.02 parts by mass and no greater than 0.06 to 100.00 parts by mass of the carrier mother particles.

As a result of having the above features, the first developer can inhibit toner scattering with less variation in amount of charge of the toner even upon toner concentration change and can form images with less fogging. The reasons therefor may be inferred as below.

In the first developer, the toner particles each include first strontium titanate particles attached to the surface of the toner mother particle. As a result of including the first strontium titanate particles with high specific permittivity, the toner particles can have a large electrostatic capacity to be frictionally charged to a desired amount of charge. Thus, toner particles not reaching, the desired amount of charge decreases, thereby achieving formation of images with less fogging.

However, as the electrostatic capacity of the toner particles is increased, the charge acceptance of the toner particles increases. When ability (also referred to below as charging ability) of the first carrier particles to frictionally charge the toner particles is low, it is difficult to supply charge, of which amount is commensurate with the charge acceptance, from the first carrier particles to the toner particles. As a result, the amount of charge of the toner largely varies when the toner concentration in the first developer changes. For example, when images are formed under a condition where the toner concentration in the first developer is liable to change, such as when the printing rate is changed, the amount of charge of the toner largely varies.

In view of the foregoing, the coat layers of the carrier mother particles of the first carrier particles contain barium titanate particles in the first developer according to the first embodiment. As a result of the first carrier particles including the coat layers containing the barium titanate particles with high specific permittivity, the electrostatic capacity of the first carrier particles increases. The carrier particles with a large electrostatic capacity can be frictionally charged to a desired amount of charge (amount of charge with a polarity opposite to that of the toner particles). Accordingly, the first carrier particles have high charging ability with a result that charge of which amount is commensurate with the charge acceptance of the toner particles can be supplied to the toner particles from the first carrier particles. Thus, variation in amount of charge of the toner can be reduced even upon toner concentration change in the first developer.

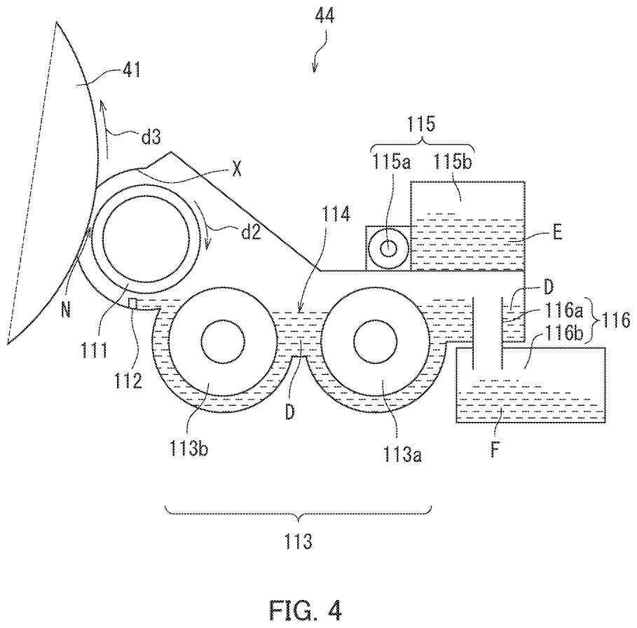

Here, the charge acceptance of the toner particles increases as the electrostatic capacity of the toner particles is increased. As such, it takes long time for the toner particles to reach the saturation charge. Therefore, it is difficult to frictionally charge the toner particles quickly, especially in a low humidity environment (e.g., an environment at a relative humidity of 5%). This is because of less water that contributes to charge supply from the first carrier particles to the toner particles in the low humidity environment. When a toner contained in a developer supplied from a replenishment section of a development device is not frictionally charged quickly, toner scattering may occur. Toner scattering is a defect in which due to some of the toner particles not being frictionally charged quickly enough to reach a desired amount of charge, some of the toner particles carried by a developer bearing member flies without moving to a light exposed area of a photosensitive member and attaches to the ceiling (e.g., a surface denoted by X in FIG. 4) of the development device.

In view of the foregoing, the first carrier particles each include the second strontium titanate particles on the surface of the carrier mother particle thereof in the first developer. As a result of the first carder particles including the second strontium titanate particles and the toner particles including the first strontium inmate particles, the energy harder in charge supply from the first carrier particles to the toner particles reduces. This increases the amount of charge transferred upon contact between the first carder particles and the toner particles. Furthermore, the second strontium inmate particles act as an external additive to increase fluidity of the first carrier particles, thereby increasing frequency of contact between the first carrier particles and the toner particles. Thus, the toner particles can be frictionally charged quickly to a desired amount of charge even in a low humidity environment and toner scattering can be inhibited.

In the toner particles of the first developer, the content ratio of the first strontium titanate particles is at least 0.3 parts by mass and no greater than 0.9 parts by mass to 100.0 parts by mass of the toner mother particles. As a result of the content ratio of the first strontium titanate particles being set to at least 0.3 parts by mass to 100.0 parts by mass of the toner mother particles, the electrostatic capacity of the toner particles can be sufficiently large, thereby achieving formation of images with less fogging. As a result of the content ratio of the first strontium titanate particles being set to no greater than 0.9 parts by mass to 100.0 parts by mass of the toner mother particles by contrast, the first strontium titanate particles hardly dissociate from the toner mother particles with a result that contact between the toner particles and the first carrier particles is hardly inhibited by the dissociated first strontium titanate particles. Thus, the toner particles can be frictionally charged to a desired amount of charge and formation of images with less fogging and inhibition of toner scattering can be achieved.

The content ratio of the barium titanate particles in the first carrier particles of the first developer is at least 2 parts by mass and no greater than 47 parts by mass to 100 parts by mass of the coating resin. When the content ratio of the barium inmate particles is at least 2 parts by mass to 100 parts by mass of the coating resin, the electrostatic capacity of the first carrier particles can be large enough and the amount of charge commensurate with the charge acceptance of the toner particles can be supplied from the first carrier particles to the toner particles. As a result, variation in amount of charge of the toner can be reduced even upon toner concentration change in the first developer. When the content ratio of the barium titanate particles is no greater than 47 parts by mass to 100 parts by mass of the coating resin by contrast, the barium titanate particles can be inhibited from dissociating from the coat layers without some of the barium titanate particles being caught into the coat layers in production. Therefore, contact between the toner particles and the first carrier particles is hardly inhibited by the dissociated barium titanate particles. As a result, the toner particles can be frictionally charged to a desired amount of charge, thereby achieving formation of images with less fogging and inhibition of toner scattering.

The second strontium titanate particles have a number average primary panicle diameter of at least 15 am and no greater than 85 nm in the first carrier particles of the first developer. As a result of the number average primary particle diameter of the second strontium titanate particles being set to at least 15 nm, charge transfer between the first carrier particles and the toner particles can be performed favorably. As a result, the toner particles can be frictionally charged quickly to a desired amount of charge even in a low humidity environment and toner scattering can be inhibited. As a result of the number average primary particle diameter of the second strontium titanate particles being set to no greater than 85 nm, the second strontium titanate particles hardly dissociate from the carrier mother particles and contact between the toner particles and the first carrier particles is hardly inhibited by the dissociated second strontium titanate particles, Thus, the toner particles can be frictionally charged to a desired amount of charge and formation of images with less fogging and inhibition of toner scattering can be achieved.

The content ratio of the second strontium titanate particles in the first carrier particles of the first developer is at least 0.02 parts by mass and no greater than 0.06 parts by mass to 100.00 parts by mass of the carrier mother particles. As a result of the content ratio of the second strontium titanate particles being set to at least 0.02 parts by mass to 100.00 parts by mass of the carrier mother particles, reduction in energy barrier in the aforementioned charge supply and increase in the frequency of the aforementioned contact can be achieved. As a result, the toner particles can be frictionally charged quickly to a desired amount of charge even in a low humidity environment and toner scattering can be inhibited. As a result of the content ratio of the second strontium titanate particles being set to no greater than 0.06 parts by mass to 100.00 parts by mass of the carrier mother particles by contrast, the toner particles and the coat layers being a charge generating source can contact with each other sufficiently because the coat layers are not excessively covered with the second strontium titanate particles. As a result, the toner particles can be frictionally charged to a desired amount of charge, thereby achieving formation of images with less fogging and inhibition of toner scattering.

The reasons have been described so far why the first developer can inhibit toner scattering with less variation in amount of charge of the toner even upon toner concentration change and can form images with less fogging.

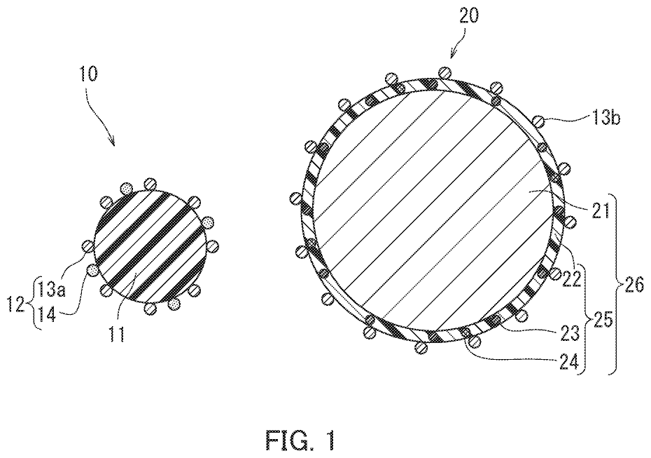

Examples of the structures of the toner particles and the first carrier particles are described below with reference to FIG. 1. FIG. 1 is a cross-sectional view of examples of a toner particle 10 and a first carrier particle 20 in the first developer.

The toner particle 10 illustrated in FIG. 1 includes a toner mother particle 11 and external additive particles 12. The toner mother particle 11 is a non-capsule toner mother particle. The external additive particles 12 are attached to (provided on) the surface of the toner mother particle 11. The external additive particles 12 includes first strontium titanate particles 13a. The external additive particles 12 may further include external additive particles 14 (also referred to below as additional toner external additive particles) other than the first strontium titanate particles 13a as necessary.

The first carrier particle 20 illustrated in FIG. 1 includes a carrier mother particle 26 and second strontium inmate particles 13b, The second strontium titanate particles 13b are attached to (provided on) the surface of the carrier mother particle 26. The carder mother particle 26 includes a carrier core 21 and a coat layer 25. The coat layer 25 covers the surface of the carrier core 21. For example, the coat layer 25 covers the entire surface of the carrier core 21. The coat layer 25 contains barium titanate particles 22 and a coating resin constituting a coating resin area 23. The coat layer 25 may further contain carbon black particles 24 as necessary.

Examples of the structures of the toner particles and the first carrier particles in the first developer have been described so far with reference to FIG. 1. However, the structures of the toner particles and the first carrier particles in the first developer are not limited particularly and can be structures different from those of the toner particle 10 and the first carrier particle 20 illustrated in FIG. 1. For example, the toner particles may not include the additional toner external additive particles. Furthermore, the toner mother particles may be capsule toner mother particles each including a toner core and a shell layer covering the toner core. It is only required that the coat layers of the first carrier particles cover at least part of the carrier cores. That is, part of the carrier cores may be exposed. Furthermore, the coat layers of the carrier particles may not contain the carbon black particles. The toner and the first carrier are described next further in detail.

### <Toner>

The toner contains toner particles. As described previously, the toiler particles each include a toner mother particle and external additive particles.

### <<External Additive Particles of Toner Particles=>

The external additive particles of the toner particles include first strontium titanate particles and the additional toner external additive particles as necessary.

### (First Strontium Titanate Particles)

The content ratio of the first strontium titanate particles is at least 0.3 parts by mass and no greater than 0.9 parts by mass to 100.0 parts by mass of the toner mother particles as described previously. In order to form images with less fogging and inhibit toner scattering, the content ratio of the first strontium titanate particles is preferably at least 0.3 parts by mass and no greater than 0.8 parts by mass to 100.0 parts by mass of the toner mother particles, and more preferably at least 0.3 parts by mass and no greater than 0.5 parts by mass.

In order to form images with less fogging and inhibit toner scattering, the first strontium titanate particles have a number average primary particle diameter of preferably at least 15 nm and no greater than 85 nm, more preferably at least 20 nm and no greater than 80 nm, further preferably at least 20 nm and no greater than 60 nm, and furthermore preferably at least 20 nm and no greater than 40 nm.

The first strontium titanate particles may be doped. When the first strontium titanate is doped, the amount of the doped element may be no greater than 1.00% by mass relative to the total mass of the first strontium titanate particles, may be no greater than 0.10% by mass, or may be less than 0.01% by mass. However, the first strontium titanate particles may not be doped. The first strontium titanate particles may be constituted by non-doped strontium titanate. For example, the first strontium titanate particles may be constituted by strontium titanate to which lanthanum and Group 5 Elements (e.g., niobium or tantalum) of the Periodic Table are not doped.

### (Additional Toner External Additive Particles)

Examples of the additional toner external additive particles include silica particles, resin particles, alumina particles, magnesium oxide particles, and zinc oxide particles. Preferable examples of the additional toner external additive particles include silica particles and resin particles.

The silica particles may be surface treated. For example, either or both hydrophobicity and positive chargeability may be imparted to the surfaces of the silica particles with a surface treatment agent. Preferably, the silica particles have a number average primary particle diameter of at least 1 nm and no greater than 60 nm.

In order to favorably fix the toner particles to recording mediums, the resin particles are preferably thermoplastic resin particles, and more preferably styrene-acrylic resin particles. The styrene-acrylic resin is a copolymer of at least one styrene-based monomer and at least one acrylic acid-based monomer. The styrene-acrylic resin is preferably a copolymer of styrene, (meth)acrylic acid alkyl ester, and divinylbenzene, and more preferably a copolymer of styrene, butyl (meth)acrylate, and divinylbenzene. Preferably, the percentage content of a repeating unit derived from styrene, the percentage content of a repeating unit derived from (meth)acrylic acid alkyl ester, and the percentage content of a repeating unit derived from divinylbenzene in all repeating units included in the styrene-acrylic resin are respectively at least 1% by mol and no greater than 30% by mol, at least 30% by mol and no greater than 50% by mol, and at least 30% by mol and no greater than 50% by mol. In order to inhibit burial of the first strontium titanate particles in the toner mother particles by the resin particle acting as spacer particles, the number average primary particle diameter of the resin particles is preferably larger than that of the first strontium titanate particles. Preferably, the resin particles have a number average primary particle diameter of at least 30 nm and no greater than 120 nm.

The amount of the additional toner external additive particles is preferably at least 0.1 parts by mass and no greater than 10.0 parts by mass relative to 100.0 parts by mass of the toner mother particles.

### <<Toner Mother Particles>>

The toner mother particles contain a hinder resin, for example. The toner mother particles may further contain at least one selected from the group consisting of a colorant, a charge control agent, and a releasing agent. The binder resin, the colorant, the charge control agent, and the releasing agent are described below.

### (Binder Resin)

In order that the toner has excellent low-temperature fixability, the toner mother particles preferably contain a thermoplastic resin as the binder resin, and more preferably contain a thermoplastic resin at a percentage content of at least 85% by mass to the total of the binder resin. Examples of the thermoplastic resin include polyester resin, styrene-based resin, acrylic acid-based resin, acrylic acid ester-based resins (specific examples include acrylic acid ester polymers and methacrylic acid ester polymers), olefin-based resins (specific examples include polyethylene resin and polypropylene resin), vinyl resins (specific examples include vinyl chloride resin, polyvinyl alcohol, vinyl ether resin, and N-vinyl resin), polyamide resin, and urethane resin. Any copolymer of these resins, that is, a copolymer (specific examples include styrene-acrylic resin and styrene butadiene resin) in which any repeating unit has been introduced into any of the above resins can be used as the binder resin.

The binder resin is preferably polyester resin. The polyester resin is a polymer of one or more polyhydric alcohol monomers and one or more polybasic carboxylic acid monomers. Note that a polybasic carboxylic acid derivative (specific examples include an anhydride of polybasic carboxylic acid and a halide of polybasic carboxylic acid may be used instead of the polybasic carboxylic acid monomer.

Examples of the polyhydric alcohol monomers include diol monomers, bisphenol monomers, and tri- or higher-hydric alcohol monomers.

Examples of the diol monomers include ethylene glycol, diethylene triethylene glycol, 1,2-propanediol, 1,3-propanediol, 1,4-butanediol, neopentyl glycol, 2-butene-1,4-diol, 1,5-pentanediol, 1,6-hexanediol, 1,4-cyclohexanedimethanol, 1,4-benzenediol, dipropylene glycol, polyethylene glycol, polypropylene glycol, and polytetramethylene glycol.

Examples of the bisphenol monomers include bisphenol A, hydrogenated bisphenol A, bisphenol A ethylene oxide adduct, and bisphenol A propylene oxide adduct.

Examples of the tri- or more-hydric alcohol monomers include sorbitol, 1,2,3,6-hexanetetrol, 1,4-sorbitan, pentaerythritol, dipentaetythritol, tripentaerythritol, 1,2,4-butanetriol, 1,2,5-pentanetriol, glycerol, diglycerol, 2-methylpropanetriol, 2-methyl-1,2,4-butanetriol, trimethylolethane, trimethylol propane, and 1,3,5-trihydroxymethylbenzene.

Examples of the polybasic carboxylic acid monomers include dibasic carboxylic acid monomers and tri- or higher-basic carboxylic acid monomers.

Examples of the dibasic carboxylic acid monomers include maleic acid, fumaric acid, citraconic acid, itaconic acid, glutaconic acid, phthalic acid, isophthalic acid, terephthalic acid, 5-sulfoisophthalic acid, sodium 5-sulfoisophthalate, cyclohexanedicarboxylic acid, adipic acid, sebacic acid, azelaic acid, malonic acid, succinic acid, alkyl succinic acids, and alkenyl succinic acids. Examples of the alkyl succinic acids include n-butylsuccinic acid, isobutylsuccinic acid, n-octylsuccinic acid, n-dodecylsuccinic acid, and isododecyl succinic acid. Examples of the alkenyl succinic acids include n-butenylsuccinic acid, isobutenylsuccinic acid, n-octenylsuccinic acid, n-dodecenylsuccinic acid, and isododecenylsuccinic acid.

Examples of the tri- or higher-basic carboxylic acid monomers include 1,2,4-acid (trimellitic acid), 2,5,7-naphthalenetricarboxylic acid, 1,2,4-naphthalenetricarboxylic acid, 1,2,4-butanetricarboxylic acid, 1,2,5-hexanetricarboxylic acid, 1,3-dicarboxyl-2-methyl-2-methylenecarboxypropane, 1,2,4-cyclohexanetricarboxylic acid, tetra(methylenecarboxyl)methane, 1,2,7,8-octanetetracarboxylic acid, pyromellitic acid, and Empor trimer acid.

The polyester resin is preferably a polymer of a bisphenol monomer, a dibasic carboxylic acid monomer, and a tribasic carboxylic acid monomer. More preferably, the polyester resin is a polymer of bisphenol A alkylene oxide adduct, dicarboxylic acid with a carbon number of at least 3 and no greater than 6, and aryl tricarboxylic acid. Further preferably, the polyester resin is a polymer of bisphenol A ethylene oxide adduct, bisphenol A propylene oxide adduct, fumaric acid, and trimellitic acid.

The polyester resin is preferably non-crystalline polyester resin. It is often not possible to determine a definite melting point for non-crystalline polyester resin. Therefore, polyester resin of which endothermic peak cannot be definitely identified on an endothermic curve plotted using a differential scanning calorimeter can be determined to be non-crystalline polyester resin.

The polyester resin has a softening point of preferably at least 50° C. and no greater than 200° C., and more preferably at least 80° C. and no greater than 120° C. The polyester resin has a glass transition point of preferably at least 40° C. and no greater than 00° C., and more preferably at least 40° C. and no greater than 60° C.

The polyester resin has a mass average molecular weight of preferably at least 10,000 and no greater than 50,000, and more preferably at least 20,000 and no greater than 40,000.

The polyester resin has a hydroxyl value of preferably at least 1 mgKOH/g and no greater than 30 mgKOH/g, and more preferably at least 10 mgKOH/g and no greater than mgKOH/g. The polyester resin has a hydroxyl value of preferably at least 1 mgKOH/g and no greater than 50 mgKOH/g, and more preferably at least 20 mgKOH/g and no greater than 40 mgKOH/g.

### (Colorant)

Any known pigment or dye can be used as the colorant according to the color of the toner, Examples of the colorant include a black colorant, a yellow colorant, a magenta colorant, and a cyan colorant.

Examples of the black colorant include carbon black. Alternatively, the black colorant may be a colorant of Which color is adjusted to a black color using a yellow colorant, a magenta colorant, and a cyan colorant.

One or more compounds selected from the group consisting of a condensed azo compound, an isoindolinone compound, an anthraquinone compound, an azo metal complex, a methine compound, and an aryl amide compound may be used as the yellow colorant. Examples of the yellow colorant include C.I. Pigment Yellow (3, 12, 13, 14, 15, 17, 62, 74, 83, 93, 94, 95, 97, 109, 110, 111, 120, 127, 128, 129, 147, 151, 154, 155, 168, 174, 175, 176, 180, 181, 191, or 194), Naphthol Yellow S, Hansa Yellow G, and C.I. Vat Yellow.

One or more compounds selected from the group consisting of a condensed azo compound, a diketopyrrolopyrrole compound, an anthraquinone compound, a quinacridone compound, a basic dye lake compound, a naphthol compound, a benzimidazolone compound, a thioindigo compound, and a perylene compound may be used as the magenta colorant. Examples of the magenta colorant include C.I. Pigment Red (2, 3, 5, 6, 7, 19, 23, 48:2, 48:3, 48:4, 57:1, 81:1, 122, 144, 146, 150, 166, 169, 177, 184, 185, 202, 206, 220, 221, or 254).

One or more compounds selected from the group consisting of a copper phthalocyanine compound, an anthraquinone compound, and a basic dye lake compound may be used as the cyan colorant. Examples of the cyan colorant include C.I. Pigment Blue (1, 7, 15, 15:1, 15:2, 15:3, 15:4, 60, 62, or 66), Phthalocyanine Blue, C.I. Vat Blue, and C.I. Acid Blue.

The amount of the colorant is preferably at least 1 part by mass and no greater than 20 parts by mass relative to 100 parts by mass of the binder resin.

### (Charge Control Agent)

The charge control agent is used for the purpose of imparting excellent charge stability and excellent charge rise characteristics to the toner, for example. The charge rise characteristic of the toner serves as an indicator as to whether the toner can be charged to a specific charge level in a short period of time. Examples of the charge control agent include a positive charge control agent and a negative charge control agent. Cationic strength (positive chargeability) of the toner can be increased through the toner mother particles containing a positive charge control agent. Anionic strength (negative chargeability) of the toner can be increased through the toner mother particles containing a negative charge control agent. Examples of the positive charge control agent include pyridine, nigrosine, and quaternary ammonium salt. Examples of the negative charge control agent include metal-containing azo dye, sun group-containing resin, oil-soluble dye, metal salts of naphthenic acid, acetylacetonate complexes, salicylic acid-based metal complexes, boron compounds, fatty acid soap, and long-chain alkyl carboxylic acid salts. However, the charge control agent need not be contained in the toner mother particles when sufficient chargeability of the toner can be ensured. The amount of the charge control agent is preferably at least 0.1 parts by mass and no greater than 10.0 parts by mass relative to 100 parts by mass of the binder resin.

### (Releasing Agent)

The releasing agent is used for the purpose of imparting excellent hot offset resistance to the toner, for example. Examples of the releasing agent include aliphatic hydrocarbon-based waxes, oxides of aliphatic hydrocarbon-based waxes, plant-derived waxes, animal-derived waxes, mineral-derived waxes, ester waxes of which main component is fatty acid ester, and waxes in which a part or all of a fatly acid ester has been deoxidized. Examples of the aliphatic hydrocarbon-based waxes include polyethylene waxes (e.g., low molecular weight polyethylene), polypropylene waxes (e.g., low molecular weight polypropylene), polyolefin copolymers, polyolefin wax, microcrystalline wax, paraffin wax, and Fischer-Tropsch way Examples of the oxides of aliphatic hydrocarbon-based waxes include oxidized polyethylene wax and block copolymers of oxidized polyethylene wax. Examples of the plant-derived waxes include candelilla wax, carnauba wax, Japan wax, jojoba wax, and rice wax. Examples of the animal-derived waxes include beeswax, lanolin, and spermaceti. Examples of the mineral-derived waxes include ozokerite, ceresin, and petrolatum. Examples of the ester waxes of which main component is fatty acid ester include montanic acid ester wax and castor wax. Examples of the waxes in which a part or all of a fatly acid ester has been deoxidized include deoxidized carnauba wax. The amount of the releasing agent is preferably at least 1 part by mass and no greater than 20 parts by mass relative to 100 parts by mass of the binder resin.

Note that the toner particles may contain a known additive as necessary. The toner particles preferably have a volume median diameter of at least 4 μm and no greater than 12 μm. The volume median diameter of the toner mother particles is preferably at least 4 μm and no greater than 12 μm, and more preferably at least 5 μm and no greater than 9 μm. When the first developer is used as an initial developer, the percentage content of the toner in the first developer is preferably at least 1% by mass and no greater than 15% by mass, and more preferably at least 3% by mass and no greater than 10% by mass. When the first developer is used as a replenishment developer, the percentage content of the toner in the first developer is preferably at least 50% by mass and no greater than 99% by mass, and more preferably at least 80% by mass and no greater than 95% by mass. The toner has been described so far.

### <First Carrier>

The first carder contains first carrier particles. As described previously, the first carrier particles each include a carrier mother particle and second strontium titanate particles.

### <<Second Strontium Titanate Panicles of First Carrier Particles>>

The content ratio of the second strontium titanate particles is at least 0.02 parts by mass and no greater than 0.06 to 100.00 parts by mass of the carder mother particles as described previously. The content ratio of the second strontium titanate particles is preferably at least 0.03 parts by mass and no greater than 0.05 to 100.00 parts by mass of the carrier mother particles in order to firm images with less fogging and inhibit toner scattering.

The second strontium titanate particles have a number average primary particle diameter of at least 15 nm and no greater than 85 nm as described previously. In order to form images with less fogging and inhibit toner scattering, the second strontium titanate particles have a number average primary particle diameter of preferably at least 20 nm and no greater than 80 nm, more preferably at least 20 nm and no greater than 60 nm, and further preferably at least 20 nm and no greater than 40 nm.

The second strontium titanate particles may be doped. When the second strontium titanate is doped, the amount of the doped element may be no greater than 1.00% by mass relative to the total mass of the second strontium titanate particles, may be no greater than 0.10% by mass, or may be less than 0.01% by mass. However, the second strontium titanate particles may not be doped. The second strontium titanate particles may be constituted by non-doped strontium titanate. For example, the second strontium titanate particles may be constituted by strontium titanate to which lanthanum and Group 5 Elements (e.g., niobium or tantalum) of the Periodic Table are not doped. In order to reduce the energy barrier in charge supply from the first carrier particles to the toner particles, the second strontium titanate particles of the first carrier particles preferably have either or both the same composition and the same number average primary particle diameter as the first strontium titanate particles of the toner particles.

### <<Carrier Mother Particles>>

As described previously, the carrier mother particles each include a carrier core and a coat layer. In order to form images with less fogging, the mass ratio (also referred to below as coat layer/core rate) of the coat layers to the carrier cores is preferably at least 2.0% by mass and no greater than 4.0% by mass.

### (Carrier Cores)

The carrier cores contain a magnetic material, for example, Examples of the magnetic material contained in the carrier cores include metal oxides. More specific examples thereof include magnetite, maghemite, and ferrite. Ferrite has high fluidity and tends to be chemically stable. Therefore, the carrier cores preferably contain ferrite in terms of forming high-quality images for a long period of term. Examples of the ferrite include barium ferrite, manganese ferrite (Mn-ferrite), Mn—Zn ferrite, Ni—Zn ferrite, Mn—Mg ferrite, Ca—Mg ferrite, Li ferrite, and Cu—Zn ferrite. The shape of the carrier cores is not particularly limited and can be irregular or spherical. The carrier cores can be commercially available. Furthermore, the carrier cores may be self-made by pulverizing and baking a magnetic material.

The carrier cores have a volume median diameter of preferably at least 20.0 μm and no greater than 65.0 μm, and more preferably at least 20.0 μm and less than 40.0 μm. As a result of the volume median diameter of the carrier cores being set to at least 20.0 μm, a defect (carrier development) in which the first carrier particles attach to a photosensitive member is less likely to occur. This can inhibit travel of the first carrier particles attached to the photosensitive member from the photosensitive member to a transfer belt, thereby achieving inhibition of occurrence of image defects such as a transfer defect. Also, occurrence of poor cleaning can be inhibited because carrier development hardly occurs. As a result of the volume median diameter of the carrier cores being set to no greater than 65.0 μm by contrast, the magnetic brush of the first developer formed on the circumferential surface of a developer bearing member in image formation is thick, thereby achieving formation of high-quality images.

Preferably, the carrier cores have a saturation magnetization of at least 65 emu/g and no greater than 90 emu/g. When the carrier cores contain Mn-ferrite, the saturation magnetization of the carrier cores tends to decrease as the percentage content of Mn is increased. When the carrier cores contain Mn—Mg ferrite, the saturation magnetization of the carrier cores also tends to decrease as the percentage content of Mg is increased.

### (Coat Layers)

As described previously, the coat layers contain a coating resin, barium titanate particles, and carbon black particles as necessary.

The coating resin is described below. The coating resin includes silicone resin. As a result of the coating resin including silicone resin, the toner can be frictionally charged in a favorable manner. Preferable examples of the silicone resin include silicone resins with a methyl group and an epoxy resin-modified silicone resin. An example of the silicone resins with a methyl group is a silicone resin with a methyl group and no phenyl groups. Another example of the silicone resins with a methyl group is a silicone resin (also referred to below as methylphenyl silicone resin) with a methyl group and a phenyl group. The coat layers may contain only the silicone resin as the coating resin or further contain a resin other than the silicone resin. The silicone resin has a percentage content of preferably at least 80% by mass relative to the mass of the coating resin, more preferably at least 90% by mass, and particularly preferably 100% by mass. The coating resin has been described so far.

The barium titanate particles are described next. As described previously, the barium titanate particles have a content ratio of at least 2 parts by mass and no greater than 47 parts by mass to 100 parts by mass of the coating resin. In order to form images with less fogging and inhibit toner scattering, the content ratio of the barium titanate particles is preferably at least 3 parts by mass and no greater than 45 parts by mass to 100 parts by mass of the coating resin, more preferably at least 3 parts by mass and no greater than 40 parts by mass, and further preferably at least 3 parts by mass and no greater than parts by mass. When the coating resin includes two or more resins, the mass of the coating resin means the total mass of the two or more resins.

Preferably, the barium titanate particles have a number average primary particle diameter of at least 100 nm and no greater than 500 nm. In order to reduce variation in amount of charge of the toner upon toner concentration change in the first developer, the number average primary particle diameter of the barium titanate particles is preferably at least 200 nm. In order to form images with less fogging, the number average primary particle diameter of the barium titanate particles is preferably no greater than 400 nm. In terms of achieving easy and uniform dispersion in the coating resin, the barium titanate particles are preferably constituted by a hydrothermal compound. The barium titanate particles have been described so far.

The carbon black particles are described next. The carbon black particles are conductive. As such, when the coat layers contain the carbon black particles, charge can smoothly move from the first carrier particles to the toner particles. As a result, the toner particles can be charged to a desired amount of charge, thereby achieving formation of images with less fogging.

The carbon black particles have a number average primary particle diameter of preferably at least 10 nm and no greater than 50 nm, and more preferably at least 30 nm and no greater than 40 nm. The carbon black particles have a dibutyl phthalate (DBP) oil absorption of preferably at least 300 cm³/100 g and no greater than 700 cm³/100 g, and more preferably at least 400 cm³/100 g and no greater than 600 cm³/100 g. The carbon black particles have a BET specific surface area of preferably at least 1000 m²/g and no greater than 2000 m²/g, and more preferably at least 1200 m²/g and no greater than 1500 m²/g. The amount of the carbon black particles is preferably at least 1 part by mass and no greater than 10 parts by mass relative to 100 parts by mass of the coating resin. The carbon black particles have been described so far.

Note that the first carrier particles may include additional carder external additive particles as necessary. The additional carrier external additive particles are appropriately selected from among known external additives. Alternatively, the first carder particles may further contain any known additive. Preferably, the first carder particles have a volume median diameter of at least 25 μm and no greater than 100 μm. The first carrier has been described so far.

### <Developer Production Method>

The following describes an example of a method for producing the first developer. The method for producing the first developer according to the first embodiment includes a process of forming the toner, a process of forming the first carder, and a process of mixing the toner and the first carrier.

### (Process of Forming Toner)

In the process of forming the toner, the binder resin, the colorant, the charge control agent, and the releasing agent are mixed to yield a mixture. The resultant mixture was melt-kneaded to obtain a melt-kneaded product. The melt-kneaded product is pulverized to obtain a pulverized product. The resultant pulverized product is classified to obtain the toner mother particles. The toner mother particles and the external additive particles (the first strontium titanate particles and any other additional toner external additive particles) are mixed using a mixer. Through mixing, the external additive particles are attached to the surfaces of the toner mother particles, thereby obtaining the toner containing the toner particles. Preferably, mixing with the external additive particles is performed under a condition where the external additive particles are not completely buried in the toner mother particles.

### (Process of Forming First Carrier)

The process forming the first carrier includes a process of forming the carrier mother particles and a process of external additive addition to the carrier mother particles.

In the process of forming the carrier mother particles, the coat layers are formed on the surfaces of the carrier cores to obtain the carrier mother particles. For example, a coating liquid containing the coating resin, the barium titanate particles, and optional carbon black particles is sprayed toward the carrier cores in a fluid bed. Next, the carrier cores toward which the coating liquid has been sprayed are heated at a first specific temperature (also referred to below as specific dry temperature) to dry the coating liquid attached to the surfaces of the carrier cores, thereby obtaining a dried product. Next, the dried product is heated at a second specific temperature (also referred to below as specific baking temperature) using an electric furnace to harden the coating resin contained in the coating liquid on the surfaces of the carrier cores. In the manner described above, the coat layers are formed on the surfaces of the carrier cores. The specific dry temperature is preferably at least 70° C. and no greater than 85° C. The specific baking temperature is preferably at least 200° C. and no greater than 300° C.

In the process of external additive addition to the carrier mother particles, the carrier mother particles and the second strontium titanate particles are mixed using a mixer. Through mixing, the second strontium titanate particles are attached to the surfaces of the carrier mother particles, thereby obtaining the carrier containing the first carrier particles. Preferably, mixing with the second strontium titanate particles is performed under a condition where the second strontium titanate particles are not completely buried in the carrier mother particles.

### (Process of Mixing Toner and First Carrier)

In the process of mixing the toner and the first carrier, the toner and the first carrier are mixed using a mixer to obtain the first developer.

### Second Embodiment: Developer Set

The following describes a developer set according to a second embodiment of the present disclosure. The developer set according to the second embodiment includes an initial developer and a replenishment developer. The initial developer and the replenishment developer are accommodated in different containers, for example.

The developer set according to the second embodiment is suitable for an image forming apparatus of so-called trickle development type described later in a third embodiment. Once development of an electrostatic latent image with an initial developer in a development device starts, the image forming apparatus of trickle development type develops the electrostatic latent image with the developer in the development device while performing discharge of the developer in the development device and replenishment of the development device with the replenishment developer. During image formation, the development device is replenished with the carrier together with the toner and the carrier in an excess replenishment amount in the development device is discharged. This can inhibit degradation of the carder in the development device. Furthermore, as a result of degradation of the carrier being inhibited, the number of times of replacement of the carrier in the development device can be reduced.

The initial developer of the developer set according to the second embodiment is the first developer described in the first embodiment. Therefore, the developer set according to the second embodiment can inhibit toner scattering with less variation in amount of charge of the toner even upon toner concentration change and can form images with less fogging for the reasons described in the first embodiment. The toner in the initial developer has a percentage content of preferably at least 1% by mass and no greater than 15% by mass, and more preferably at least 3% by mass and no greater than 10% by mass.

The replenishment developer of the developer set according to the second embodiment may be the first developer described in the first embodiment or a second developer described later. The percentage content of the toner in the replenishment developer is preferably at least 50% by mass and no greater than 99% by mass, and more preferably at least 80% by mass and no greater than 95% by mass.

<Second Developer>

The second developer is an example of the replenishment developer. The second developer contains a toner and a second carrier. The toner contains toner particles. The second carrier contains second carrier particles. The second carrier particles each include a carrier mother particle. The second developer mainly differs from the first developer described in the first embodiment in that the second carrier particles substantially do not include second strontium titanate particles on the surfaces of the carrier mother particles thereof.

Examples of the toner of the second developer include toners like the toner of the first developer described in the first embodiment.

Examples of the carrier mother particles of the second carrier particles in the second carrier contained in the second developer include carrier mother particles like the carrier mother particles of the first carrier particles described in the first embodiment. The second carrier particles substantially include no strontium titanate particles on the surfaces of the second carrier mother particles. In the present specification, the phrase substantially including no second strontium titanate particles means inclusion of no second strontium titanate particles or a content ratio of the second strontium titanate particles being no greater than 0.01 parts by mass to 100.00 parts by mass of the carrier mother particles.

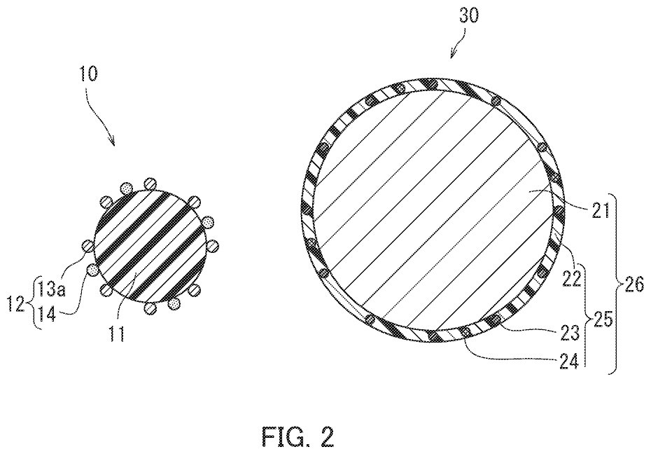

Examples of the structures of the toner particles and the second carrier particles each contained in the second developer are described below with reference to FIG. 2. FIG. 2 is a cross-sectional view of examples of a toner particle 10 and a second carrier particle 30 each contained in the second developer. Note that the same reference signs are assigned to the same elements of configuration included in the second developer as those in the first embodiment and description thereof is not repeated.

The toner particle 10 illustrated in FIG. 2 has the same configuration as the toner particle 10 illustrated in FIG. 1. The second carrier particle 20 illustrated in FIG. 2 includes a carrier mother particle 26. The carrier mother particle 26 illustrated in FIG. 2 has the same configuration as the carrier mother particle 26 illustrated in FIG. 1, The second carrier particle 30 illustrated in FIG. 2 substantially include no second strontium titanate particles 13b on the surface of the carrier mother particle 26.

Examples of the structures of the toner particles and the second carrier particles each contained in the second developer have been described so far with reference to FIG. 2. However, the structures of the toner particles and the second carrier particles contained in the second developer are not limited particularly and may differ from those of the toner particle 10 and the second carrier particle 30 illustrate in FIG. 2, respectively. For example, the toner particle 10 and the second carrier particle 30 illustrated in FIG. 2 may be reduced to practice with alteration similar to that for the structures of the toner particle 10 and the first carrier particle 20 described in the first embodiment.

The developer set according to the second embodiment includes the first developer as an initial developer and the second developer as a replenishment developer. In this case, some of the second strontium titanate particles of the first carrier particles in the initial developer move to the surfaces of the carrier mother particles of the second carrier particles in the replenishment developer in an accommodation section of a development device. Therefore, the developer set including the second developer as a replenishment developer can inhibit toner scattering both at the beginning and after printing with less variation in amount of charge of the toner even upon toner concentration change and can form images with less fogging to the same extent as the developer set including the first developer as a replenishment developer. Furthermore, by not including the second strontium titanate particles in the second developer, the manufacturing cost of the second developer can be reduced compared to that of the first developer. Therefore, the manufacturing cost of the developer set including the second developer as a replenishment developer can be reduced compared to a developer set including the first developer as a replenishment developer.

### Third Embodiment: Image Forming Apparatus

The following describes an image forming apparatus according to a third embodiment. The image forming apparatus according to the third embodiment includes at least a developer and a development device. The development device develops an electrostatic latent image with the developer. The developer includes an initial developer. The development device includes an accommodation section that accommodates the initial developer. The initial developer is the first developer described in the first embodiment. As a result of including the first developer according to the first embodiment as an initial developer, the image forming apparatus according to the third embodiment can inhibit toner scattering with less variation in amount of charge of the toner even upon toner concentration change and can form images with less fogging for the reasons described in the first embodiment.

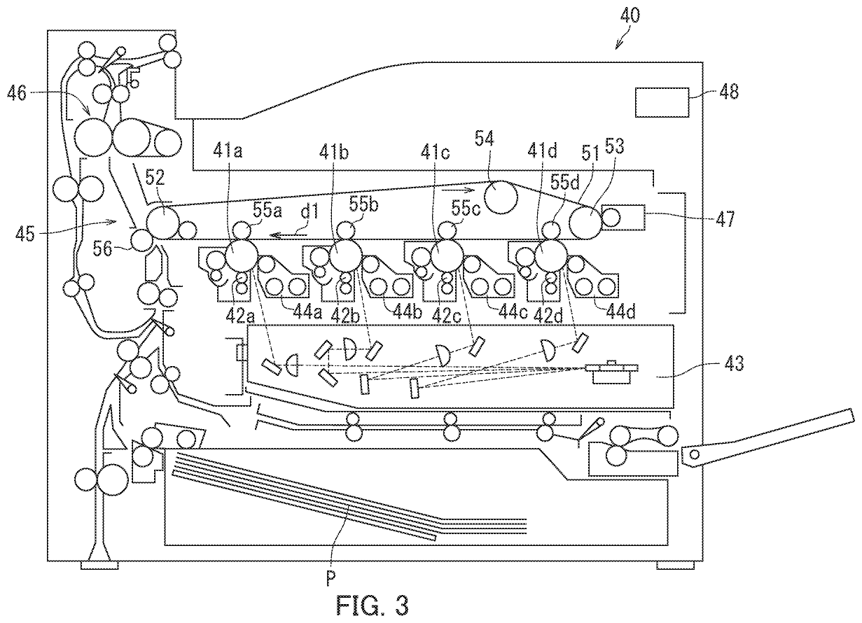

With reference to FIG. 3, an image forming apparatus 40, which is an example of the image forming apparatus according to the third embodiment, is described below.

The image forming apparatus 40 illustrated in FIG. 3 includes a developer (an in-use developer D and a replenishment developer E, see FIG. 4), a photosensitive member 41a to a photosensitive member 41d, a charger 42a to a charger 42d, a light exposure device 43, a development device 44a to a development device 44d, a transfer device 45, a fixing device 46, a cleaning device 47, and a controller 48. In the following, the photosensitive member 41a to the photosensitive member 41d are each referred to as photosensitive member 41, the charger 42a to the charger 42d are each referred to as to charger 42, and the development device 44a to the development device 44d are each referred to as development device 44 where there is no need to distinguish them.

The developer includes an in-use developer D and a replenishment developer E. The in-use developer D includes at least an initial developer. The initial developer is the first developer described in the first embodiment. The replenishment developer E is the second developer described in the second embodiment. As a result of provision of the second developer as the replenishment developer E, manufacturing cost can be reduced. However, the replenishment developer E may be the first developer described in the first embodiment.

Each of the photosensitive members 41 is cylindrical in shape. The photosensitive member 41 includes a metal-made cylindrical body (e.g., a cylindrical conductive substrate) as a core, A photosensitive layer is provided around the core. The photosensitive member 41 is supported in a rotatable manner. The photosensitive member 41 is rotationally driven by a motor (not illustrated).

Each of the chargers 42 charges the circumferential surface of a corresponding one of the photosensitive members 41.

The light exposure device 43 irradiates the charged circumferential surfaces of the photosensitive members 41 with light to form electrostatic latent images on the circumferential surfaces of the photosensitive members 41. For example, the electrostatic latent images are formed on the surface layer portions (photosensitive layers) of the photosensitive members 41 based on image data.

The development devices 44 develop the electrostatic latent images with the in-use developer D. More specifically, the development devices 44 develop the electrostatic latent images formed on the circumferential surfaces of the photosensitive members 41 into toner images with the in-use developer D. The development devices 44 are described later in detail.

The transfer device 45 includes a transfer belt 51, a drive roller 52, a driven roller 53, a tension roller 54, a primary transfer roller 55a to a primary transfer roller 55d, and a secondary transfer roller 56. In the following, the primary transfer roller 55a to the primary transfer roller 55d are each referred to as primary transfer roller 55 where there is no need to distinguish them. The transfer belt 51 is an endless belt wound among the drive roller 52, the driven roller 53, and the tension roller 54. Rotation of the drive roller 52 causes circulation of the transfer belt 51 in the clockwise direction (an arrow direction d3) in FIG. 3. The driven roller 53 and the tension roller 54 are rotationally driven by circulation of the transfer belt 51.

Once the toner images are formed on the photosensitive member 41a to the photosensitive member 41d, toner (tone images) attached to the photosensitive member 41a to the photosensitive member 41d is primarily transferred to the transfer belt 51 in a sequential manner by bias (voltage) application to the primary transfer roller 55a to the primary transfer roller 55d. In the manner described above, the toner images in multiple colors are superimposed on the transfer belt 51. After primarily transfer, bias (voltage) is applied to the secondary transfer roller 56, thereby secondarily transferring the toner images in multiple colors on the transfer belt 51 to a recording medium P (e.g., printing paper) that is being conveyed. Thereafter, the toner images in multiple colors superimposed on the transfer belt 51 are secondarily transferred in a batch to the recording medium P. In the manner described above, an image constituted by unfixed toner is formed on the recording medium P.

After secondary transfer, the fixing device 46 applies heat and pressure to the toner on the recording medium P to fix the toner to the recording medium P. In the manner described above, an image constituted by the fixed toner is formed on the recording medium P.

The cleaning device 47 cleans toner remaining on the transfer belt 51 after secondary transfer.

The controller 48 electronically controls the operation of the image forming apparatus 40 based on outputs from various sensors. The controller 48 includes a central processing unit (CPU), random-access memory, and a storage device that stores programs therein and that stores specific data therein in a rewritable manner, for example. A user provides an instruction (e.g., an electric signal) to the controller 48 through an input section (not illustrated). The input section is a keyboard, a mouse, or a touch panel, for example.

<Development Device>

With reference to FIG. 4, the development devices 44 are described next further in detail. FIG. 4 illustrates a development device 44 and its surroundings in the image forming apparatus 40 illustrated in FIG. 3. The development device 44 includes at least an accommodation section 114. The development device 44 further includes a developer bearing member 111, a restriction blade 112, a plurality of stirring shafts 113, a replenishment section 115, and a discharge section 116. The development device 44 is a development device 44 of so-called trickle development type including the accommodation section 114, the replenishment section 115, and the discharge section 116.

The accommodation section 114 accommodates the in-use developer D and the stirring shafts 113. The in-use developer D (i.e., accommodated developer) accommodated in the accommodation section 114 includes the initial developer. The stirring shafts 113 include a first stirring shaft 113a and a second stirring shaft 113b. The first stirring shaft 113a includes a spiral stirring vane. The second stirring shaft 113b includes a spiral stirring vane that faces in the opposite direction (opposite phase) to the direction in which the spiral stirring vane of the first stirring shaft 113a faces. The first stirring shaft 113a conveys the in-use developer D in a first conveyance direction (direction perpendicular to the paper surface in FIG. 4 and a direction from the back to the front of the paper) from one end to the other end of the developer bearing member 111 in the axial direction thereof while stirring the in-use developer D in the accommodation section 114. The second stirring shaft 113b conveys the in-use developer D in a second conveyance direction opposite to the first conveyance direction while stirring the in-use developer D in the accommodation section 114. When the in-use developer D containing toner and carrier is stirred, the toner is charged by friction with the carrier and the charged toner is carried by the carrier. The second stirring shaft 113b supplies the in-use developer ID to the developer bearing member 111 while conveying the in-use developer D in the second conveyance direction.

The replenishment section 115 is provided above the accommodation section 114. The replenishment section 115 replenishes the accommodation section 114 with the replenishment developer E. The replenishment section 115 includes a replenishment amount adjusting member 115a and a developer container 115b.

The replenishment amount adjusting member 115a controls the replenishment amount of the replenishment developer E to be supplied to the accommodation section 114 from the developer container 115b. The replenishment amount adjusting member 115a is constituted by a screw shaft of which rotation operation is controlled by the controller 48, for example. For example, the replenishment amount of the replenishment developer E can be changed according to the amount of rotation of the screw shaft.

The developer container 115b accommodates the replenishment developer E. The replenishment developer E in the developer container 115b is supplied to the accommodation section 114.

The discharge section 116 discharges the in-use developer D in the accommodation section 114. The discharge section 116 includes a discharge path 116a and a collection container 116b. The discharge path 116a connects the accommodation section 114 and the collection container 116b. When the amount of the in-use developer D in the accommodation section 114 exceeds a specific amount, excess in-use developer D flows into the discharge path 116a from an opening at the upper end of the discharge path 116a. The specific amount is an amount determined according to the position of the upper end of the discharge path 116a, for example. The excess in-use developer D is in-use developer D in an amount in excess of the specific amount, for example. The excess in-use developer D, after entering the discharge path 116a, travels downward within the discharge path 116a due to its own weight and flows into the collection container 116b. Then, the collection container 116b collects the excess in-use developer D as post-collection developer F (collected developer).

In the image forming apparatus 40 (e.g., an unused image forming apparatus 40) before image formation begins, the in-use developer D accommodated in the accommodation section 114 is the initial developer.

Before replenishment of the accommodation section 114 with the replenishment developer E by the replenishment section 115 after image formation begins, the in-use developer D accommodated in the accommodation section 114 is the initial developer. In the accommodation section 114, the stirring shafts 113 stir the initial developer to frictionally charge the toner particles 10 contained in the initial developer. Thereafter, the stirred initial developer is carried by the developer bearing member 111.

When printing by the image forming apparatus 40 is continued, replenishment of the accommodation section 114 with the replenishment developer E and discharge of the in-use developer D from the accommodation section 114 are performed. As such, continuation of printing by the image forming apparatus 40 causes replacement of the in-use developer D accommodated in the accommodation section 114 with the replenishment developer E supplied from the replenishment section 115 little by little. The in-use developer D accommodated in the accommodation section 114 after replenishment of the accommodation section 114 with the replenishment developer E by the replenishment section 115 includes the initial developer and the replenishment developer E. Once the replenishment section 115 replenishes the accommodation section 114 with the replenishment developer E, the initial developer and the replenishment developer E are stirred by the stirring shafts 113 in the accommodation section 114, with a result that the toner particles 10 contained in the initial developer and the toner particles 10 contained in the replenishment developer E are frictionally charged. Thereafter, the stirred initial developer and the stirred replenishment developer E are carried by the developer bearing member 111.

The developer hearing member 111 is located in the vicinity of the photosensitive member 41. The developer bearing member 111 includes a magnet roll and a development sleeve. The magnet roll has magnetic poles at at least a surface layer portion thereof. The magnetic poles include an N pole and an S pole based on a permanent magnet, for example. The development sleeve is a non-magnetic cylinder (e.g., an aluminum pipe). The magnet roll is located in the development sleeve (cylinder), and the development sleeve is located on the surface layer portion of the developer bearing member 111. The shaft of the magnet roll, which is nonrotatable, and the development sleeve are connected to each other by a flange in a manner that the development sleeve is rotatable around the magnet roll.

As described previously, the charged toner is carried by the carrier in the accommodation section 114. The developer bearing member 111 (specifically, the development sleeve) attracts the carrier in the accommodation section 114 by the magnetic tierce thereof while rotating in the clockwise direction (an arrow direction d2) in FIG. 4 to carry, on the circumferential surface thereof, the carrier (i.e., the in-use developer D) carrying the toner. Thereafter, a magnetic brush is formed with the in-use developer D carried by the developer bearing member 111.

The restriction blade 112 restricts the thickness of the magnetic brush of the in-use developer D firmed on the circumferential surface of the developer hearing member 111 to a specific thickness.

After the thickness of the magnetic brush is restricted by the restriction blade 112, the developer bearing member 111 (specifically, the development sleeve) further rotates in the clockwise direction (the arrow direction d2 in FIG. 4) to convey the in-use developer D to a proximal part N. The proximal part. N refers to a part of a space between the photosensitive member 41 and the developer bearing member 111 that has the shortest distance therebetween. The photosensitive member 41 rotates in the anticlockwise direction (the arrow direction d3) in FIG. 4. Bias (voltage) application to the developer bearing member 111 generates a potential difference between the surface potential of the developer bearing member 111 and the surface potential of the photosensitive member 41. Due to presence of the potential difference, the toner contained in the in-use developer D carried by the developer bearing member 111 moves to the circumferential surface of the photosensitive member 41. In detail, the charged toner contained in the in-use developer D carried by the developer bearing member 111 is attracted by electric force to an electrostatic latent image (e.g., an exposed part of which potential is reduced by light exposure to be lower than that of the non-exposed part) formed on the photosensitive member 41, thereby moving to the electrostatic latent image on the photosensitive member 41. As a result, a toner image is formed on the circumferential surface of the photosensitive member 41.

The image forming apparatus 40 according to the third embodiment has been described so far with reference to FIGS. 3 and 4. However, the image forming apparatus according to the third embodiment is not limited to the above image forming apparatus and may be implemented in various manners within a scope not departing from the gist thereof. For example, some elements of configuration may be omitted from all the elements of configuration indicated in the embodiment. Properties such as material, shape, and dimension of each element of configuration are only examples and not limited particularly. Various alterations can be practiced.

### Examples

The following provides further specific description of the present disclosure through use of Examples. However, the present disclosure is not limited to the scope of Examples.

### [Developer Preparation]

Developers (A1) to (A11) and (B1) to (B9) were prepared. Table 1 shows materials used in these developers and their amounts.

TABLE 1

| | | Toner | | Carrier | | |
|---|---|---|---|---|---|---|
| | | ST1 | | BT | ST2 | |
| | Deve- | Diameter | Amount | Amount | Diameter | Amount |
| | loper | [nm] | [part] | [part] | [nm] | [part] |
| Example 1 | A1 | 30 | 0.5 | 30 | 30 | 0.04 |
| Example 2 | A2 | 30 | 0.5 | 30 | 30 | 0.02 |
| Example 3 | A3 | 30 | 0.5 | 30 | 30 | 0.06 |
| Comparative | B1 | 30 | 0.5 | 30 | None | None |
| Example 1 | | | | | | |
| Comparative | B2 | 30 | 0.5 | 30 | 30 | 0.01 |
| Example 2 | | | | | | |
| Comparative | B3 | 30 | 0.5 | 30 | 30 | 0.07 |
| Example 3 | | | | | | |
| Example 4 | A4 | 20 | 0.5 | 30 | 20 | 0.04 |
| Example 5 | A5 | 40 | 0.5 | 30 | 40 | 0.04 |
| Example 6 | A6 | 60 | 0.5 | 30 | 60 | 0.04 |
| Example 7 | A7 | 80 | 0.5 | 30 | 80 | 0.04 |
| Comparative | B4 | 10 | 0.5 | 30 | 10 | 0.04 |
| Example 4 | | | | | | |
| Comparative | B5 | 90 | 0.5 | 30 | 90 | 0.04 |
| Example 5 | | | | | | |
| Example 8 | A8 | 30 | 0.5 | 3 | 30 | 0.04 |
| Example 9 | A9 | 30 | 0.5 | 45 | 30 | 0.04 |
| Comparative | B6 | 30 | 0.5 | 1 | 30 | 0.04 |
| Example 6 | | | | | | |
| Comparative | B7 | 30 | 0.5 | 50 | 30 | 0.04 |
| Example 7 | | | | | | |
| Example 10 | A10 | 30 | 0.3 | 30 | 30 | 0.04 |
| Example 11 | A11 | 30 | 0.9 | 30 | 30 | 0.04 |
| Comparative | B8 | 30 | 0.2 | 30 | 30 | 0.04 |
| Example 8 | | | | | | |
| Comparative | B9 | 30 | 1.0 | 30 | 30 | 0.04 |
| Example 9 | | | | | | |

The terms in Table 1 mean as follows.
ST1: first strontium titanate particles
“Diameter” under column “ST1”: number average primary particle diameter (unit: nm) of first strontium titanate particles
“Amount” under column “ST1”: content ratio (unit:part by mass) of first strontium titanate particles relative to 100.0 parts by mass of toner mother particles
ST2: second strontium titanate particles
“Diameter” under column “ST2”: number average primary particle diameter (unit: nm) of second strontium titanate particles
“Amount” under column “ST2”: content ratio (unit:part by mass) of second strontium titanate particles relative to 100.0 parts by mass of carrier mother particles
BT: barium titanate particles
“Amount” under column “BT”: content ratio (unit:part by mass) of barium titanate particles relative to 100 parts by mass of coating resin Note that the mass of the coating resin corresponds to the solid content of a coating resin solution (e.g., a silicon resin solution).
Part: part by mass
None: No use of corresponding material

### [Preparation of Developer (A1)]

### <Toner Preparation>

A toner used in preparation of the developer (A1) was prepared according to the following method.

### (Synthesis of Non-Crystalline Polyester Resin (R1))

A non-crystalline polyester resin (R1) used as a binder resin in toner mother particle preparation was synthesized according to the following method. First, a reaction vessel equipped with a thermometer (thermocouple), a dewatering conduit, a nitrogen gas inlet tube, and a stirring device (stirring impeller) was set in an oil bath. The reaction vessel was charged with 1575 g of bisphenol A propylene oxide adduct (BPA-PO), 163 g of bisphenol A ethylene oxide adduct (BPA-EO). 377 g of fumaric acid, and 4 g of a catalyst (dibutyl tin oxide). Subsequently, the inside of the reaction vessel was placed in a nitrogen atmosphere and the internal temperature of the reaction vessel was raised to 220° C. using the oil bath while stirring of the contents of the reaction vessel. A polymerization reaction of the contents of the reaction vessel was caused for 8 hours while the byproduct water was distilled in the nitrogen atmosphere at a temperature of 220° C. Subsequently, the internal pressure of the reaction vessel was reduced and the polymerization reaction of the contents of the reaction vessel was further caused in the reduced pressure atmosphere (pressure: 7999 Pa) at a temperature of 220° C. Subsequently, the internal temperature of the reaction vessel was reduced to 210° C. and 336 g of trimellitic anhydride was added into the reaction vessel. The contents of the reaction vessel were then caused to react in the reduced pressure atmosphere (pressure: 60 mmHg) at a temperature of 210° C. The reaction time was adjusted so that a non-crystalline polyester resin (R1) being a reaction product had the following physical properties. Thereafter, the reaction product was taken out of the reaction vessel and cooled to obtain the non-crystalline polyester resin (R1) with the following physical properties. Note that the resultant polyester resin (R1) was determined to be non-crystalline because an endothermic peak was not definitely identified on an endothermic curve plotted using a differential scanning calorimeter to disable determination of a definite melting point.

### (Physical Properties of Non-crystalline Polyester Resin (R1))

Softening point (Tm): 100° C.
Glass transition point (Tg): 50° C.
Mass average molecular weight (Mw): 30,000
Acid value: 15 mgKOH/g
Hydroxyl value: 30 mgKOH/g

(Toner Mother Particle Preparation)

Using an FM mixer (“FM-10B”, product of Nippon Coke & Engineering Co., Ltd.), 100 parts by mass of a hinder resin, 4 parts by mass of a colorant, 1 part by mass of a charge control agent, and 5 parts by mass of a releasing agent were mixed to yield a mixture. The binder resin used was the non-crystalline polyester resin (R1). The colorant used was a copper phthalocyanine blue pigment (C.I. Pigment Blue 15:3), The charge control agent used was a quaternary ammonium salt (“BONTRON (registered Japanese trademark) P-51”, product of ORIENT CHEMICAL INDUSTRIES CO., LTD.). The releasing agent used was a carnauba wax (“SPECIAL CARNAUBA WAX No. 1”, product of S. Kato & Co.), The resultant mixture was melt-kneaded using a twin screw extruder (“PCM-30”, product of Ikegai Corp.) to obtain a melt-kneaded product. The resultant melt-kneaded product was pulverized using a mechanical pulverizer (“TURBO MILL”, product of FREUND-TURBO CORPORATION) to obtain a pulverized product. The resultant pulverized product was classified using a classifier (“ELBOW JET”, product of Nittetsu Mining Co., Ltd.). Through the above, toner mother particles in powder form with a volume median diameter of 6.8 μm were obtained.

(External Additive Addition to Toner Mother Particles)

Using an FM mixer (“FM-10B”, product of Nippon Coke & Engineering Co., Ltd.), 100.0 parts by mass of the toner mother particles obtained above, 1.5 parts by mass of silica particles, 0.5 parts by mass of the first strontium titanate particles, and 0.9 parts by mass of resin particles were mixed for 5 minutes at 4,000 rpm to obtain a mixture. The silica particles used were “AEROSIL (registered Japanese trademark) REA90” produced by NIPPON AEROSIL CO., LTD. (dry silica particles to which positive chargeability has been imparted through surface treatment, number average primary particle diameter 20 nm). The first strontium titanate particles used were non-doped strontium titanate (particle size adjusted product of “SW-100” produced by Titan Kogyo, Ltd.) with the particle diameter adjusted to have a number average primary particle diameter of 30 nm. The resin particles used were styrene-acrylic resin particles with a number average primary particle diameter of 40 nm. The styrene-acrylic resin constituting the resin particles was a copolymer of 20% by mol of styrene, 40% by mol of butyl methacrylate, and 40% mol of divinylbenzene. The resultant mixture was sifted using a 200-mesh sieve (opening 75 μm), thereby obtaining a toner.

### <Carrier Preparation>

A carrier used in preparation of the developer (A1) was prepared according to the following method.

### (Preparation of Coating Liquid (L1))

A coating liquid (L1) was prepared for use in formation of coat layers of the carrier. A stainless steel vessel was charged with 1000 parts by mass of a silicone resin solution (solid content: 500 parts by mass), 150 parts by mass of barium titanate, 30 parts by mass of carbon black, and 1450 parts by mass of toluene. The vessel contents were mixed using a homogenizer to obtain the coating liquid (L1). The silicone resin solution used was “KR-255” (product of Shin-Etsu Chemical Co., Ltd., solid content: methylphenyl silicone resin, solid concentration: 50% by mass). The barium titanate used was barium titanate (number average primary particle diameter: 300 nm) produced by KCM Corporation. The carbon black used was “KETJENBLACK (registered Japanese trademark) EC600JD” (product of Lion Specialty Chemicals Co., Ltd., DBP oil absorption: 495 cm³/100 g, BET specific surface area: 1270 m²/g, number average primary particle diameter: 34.0 nm) being a conductive carbon black.

### (Carrier Mother Particle Preparation)

The coating liquid (L1) was sprayed toward 5000 g of carrier cores while the carrier cores were allowed to flow using a fluidized bed coating apparatus (“FD-MP-01 Type D”, product of Powrex Corporation). The carrier cores used were manganese ferrite cores (product of DOWA IP CREATION CO., LTD., volume median diameter: 39 μm, saturation magnetization: 80 emu/g). Coating was done under conditions of a fed air temperature of 80° C., a fed flow rate of 0.3 m³/min, and a rotor rotational speed of 400 rpm. The amount of the coating liquid (L1) loaded into the fluidized bed coating apparatus was adjusted so that the coat layer/core ratio was 2.2% by mass (i.e., so that the mass of the coat layers formed by heating was 22 g relative to 1000 g of the carrier cores). Carrier cores coated with the coating liquid (L1) were obtained by the spraying. Next, the carrier cores coated with the coating liquid (L1) were heated at 250° C. for 2 hours using an oven to form coat layers on the surfaces of the carrier cores. Through the above, carrier mother particles were obtained.

### (External Additive Addition to Carder Mother Particles)

Using a ROCKING MIXER (registered Japanese trademark) (RM-10”, product of AICHI ELECTRIC CO., LTD.), 100.00 parts by mass of the carrier mother particles obtained above and 0.04 parts by mass of the second strontium titanate particles were mixed for 30 minutes to attach the second strontium titanate particles to the surfaces of the carrier mother particles. In the manner described above, a carrier containing carrier particles was obtained. The second strontium titanate particles used were non-doped strontium titanate (particle size adjusted product of “SW-100” produced by Titan Kogyo, Ltd.) with the particle diameter adjusted to have a number average primary particle diameter of 30 nm.

### <Initial Developer Preparation>

Using a shaker mixer (“TURBULA (registered Japanese trademark) Mixer T2F”, product of Willy A. Bachofen AG (WAB)), 92 parts by mass of the carrier and 8 parts by mass of the toner were mixed for 30 minutes. Through the above, a developer (A1) for initial development use was obtained. The toner concentration of the developer (A1) for initial developer use was 8% by mass.

### <Replenishment Developer Preparation>

Using a shaker mixer (“TURBULA (registered Japanese trademark) Mixer T2F”, product of Willy A. Bachofen AG (WAB)), 10 parts by mass of the carrier and 90 parts by mass of the toner were mixed for 30 minutes. Through the above, a developer (A1) for replenishment development use was obtained. The toner concentration of the developer (A1) for replenishment developer use was 90% by mass.

### [Preparation of Developers (A-2), (A-3), (B-2), and (B-3)]

Developers (A-2), (A-3), (B-2), and (B-3) were prepared according to the same method as that for preparing the developer (A1) in all aspects other than that the amount of the second strontium titanate particles added was changed as shown in Table 1 in “External Additive Addition to Carrier Mother Particles” described above.

[Preparation of Developer (B1)]

A developer (B1) was prepared according to the same method as that for preparing the developer (A1) in all aspects other than that the second strontium inmate particles were not added in “External Additive Addition to Carrier Mother Particles” described above.

[Preparation of Developers (A-4) to (A-7), (B-4), and (B-5)]

Developers (A-4) to (A-7), (B-4), and (B-5) were prepared according to the same method as that for preparing the developer (A1) in all aspects other than that strontium titanate particles with number average primary particle diameters shown in Table 1 were added as the first strontium tamale particles used in “External Additive Addition to Toner Mother Particles” described above and the second strontium titanate particles used in “External Additive Addition to Carrier Mother Particles” described above. Non-doped strontium titanate (particle size adjusted product of “SW-100” produced by Titan Kogyo, Ltd.) with the particle diameters adjusted to the respective number average primary particle diameters were used as the strontium titanate particles with the number average primary particle diameters shown in Table 1.

[Preparation of Developers (A8), (A9), (B6), and (B7)]

Developers (A8), (A9), (B6), and (B7) were prepared according to the same method as that for preparing the developer (A1) in all aspects other than that the amount of the barium titanate particles added was changed so that the content ratio of the barium titanate particles relative to 100 parts by mass of the coating resin was as shown in Table 1 in “Preparation of Coating liquid (L1)” described above. Note that the amount of the silicon resin solution added remained unchanged to 1000 parts by mass (solid content: 500 part by mass) in “Preparation of Coating Liquid (L1)” described above. For example, in the preparation of the developer (A8), the amount of the silicone resin solution added remained unchanged at 1000 parts by mass (solid content: 500 parts by mass) and the amount of the barium titanate particles added was changed to 15 parts by mass.

### [Preparation of Developers (A10), (A11), (B-8), and (B-9)]

Developers (A10), (A11), (B8), and (B9) were prepared according to the same method as that for preparing the developer (A1) in all aspects other than that the amount of the first strontium titanate particles added was changed as shown in Table 1 in “External Additive Addition to Toner Mother Particles” described above.

### [Measurement of Number Average Primary Particle Diameters]

Each number average primary particle diameter of the first and second strontium titanate particles, the barium titanate particles, and the resin particles were measured using a scanning electron microscope (“JSM-7600F”, product of JEOL Ltd., field emission scanning electron microscope). In the measurement of each number average primary particle diameter, equivalent circle diameters (Heywood diameters: diameters of circles having the same areas as projected areas of the primary particles) of 100 primary particles were measured and a number average thereof was obtained.

### [Evaluation 1]

With reference to each of the developers (A1) to (A11) and (B1) to (B9), fogging, initial toner scattering, and charge stability were evaluated according to the following methods. Evaluation values are shown below in Table 2. The rating is shown in Table 2 only for each case rated as defective (NG).

### <Evaluation Apparatus Used in Evaluation of Fogging and Toner Scattering>

As an evaluation apparatus used for evaluation of fogging and toner scattering, “TASKalfa 7054ci” produced by KYOCERA Document Solutions Inc. was used. The evaluation apparatus included an amorphous silicon drum being a photosensitive member and a development device using two-component developers. The development device had the configuration described with reference to FIG. 4.

One of the developers shown under the column “Initial developer” in Table 2 was loaded into an accommodation section of the development device. One of the developers shown under the column “Replenishment developer” in Table 2 was loaded into a replenishment section of the development device. Note that the toner concentration in the initial developer was 8% by mass and the toner concentration in the replenishment developer was 90% by mass in each evaluation.

### <Fogging>

Evaluation of fogging was carried out in an environment at a temperature of 23° C. and a relative humidity of 65%. Using the evaluation apparatus, intermittent printing was carried out by which an image I (character pattern image with a printing rate of 4%) was printed on 100,000 sheets of paper. The intermittent printing was repetition of a series of operations of consecutive printing on 7 sheets of the paper and temporary stop thereafter. After the 100,000-sheet printing, an image A (image including a solid image area and a blank area) was printed on one sheet of paper using the evaluation apparatus. The reflection density of the blank area of the sheet with the image A printed thereon was measured using a white light meter (“TC-6DS”, product of Tokyo Denshoku Co., Ltd.). A togging density (evaluation value) was calculated using an equation “fogging density=(reflection density of blank area)−(reflection density of sheet of non-printed paper)”. Whether or not fogging has been inhibited was evaluated according to the following criteria.

(Criteria of Fogging Density)
Very good: fogging density of less than 0.002
Good: fogging density of at least 0.002 and less than 0.005
Defective (NG): fogging density of at least 0.005

### <Toner Scattering (Initial)>

Evaluation of initial toner scattering was carried out in an environment at a temperature of 23° C. and a relative humidity of 5%. Using the evaluation apparatus, the image I (character pattern image with a printing rate of 4%) was printed on 1,000 sheets of paper. After the 1000-sheet printing, commercially available adhesive tape was attached to the ceiling (the surface denoted by X in FIG. 4) of the development device and peeled off. In the manner described above, adhesive tape with toner (scattered toner) scattered to the ceiling attached thereto was obtained. The reflection density of the adhesive tape with scattered toner attached thereto was measured using a white light meter (“TC-6DS”, product of Tokyo Denshoku Co., Ltd.). An initial scattered toner concentration (evaluation value) was then calculated using an equation “scattered toner concentration=(reflection density of adhesive tape with scattered toner)−(reflection density of unused adhesive tape)”. Whether or not initial toner scattering has been inhibited was evaluated according to the following criteria.

### (Criteria of Inhibition of Toner Scattering)

Very good: scattered toner density of less than 0.080
Good: scattered toner density of at least 0.080 and less than 0.100
Poor (NG): scattered toner density of at least 0.100

### <Charge Stability>

Evaluation of charge stability against change in toner concentration (also referred to below as in-developer toner concentration) in each developer was carried out in an environment at a temperature of 25° C. and a relative humidity of 50%. The carriers and the toners before being mixed in “Initial Developer Preparation” and “Replenishment Developer Preparation” described above were used in evaluation of charge stability. First, 10.0 g of one of the carriers and 0.3 g of one of the toners were added into a plastic bottle with a capacity of 20 mL. The contents of the plastic bottle was stirred at a rotational speed of 96 rpm for 30 minutes using a shaker mixer (“TURBULA (registered Japanese trademark) Mixer T2F”, product of Willy A. Bachofen AG (WAB)). Directly after the stirring, the amount (unit: μC/g)) of charge of the toner contained in the developer in the plastic bottle was measured using a compact toner draw-off charge measurement system (“MODEL 212HS”, product of TREK, INC.). The measured amount of charge was taken to be an amount of charge (T/C 3% charge amount) of the toner at a mass ratio (hereinafter referred to as “T/C”) to the carrier of 3% by mass.

The amount of charge of the toner at a T/C of 6% by mass (T/C 6% charge amount) was measured according to the same method as that for measurement of the toner with the T/C 3% charge amount in all aspects other than that 10.0 g of the carrier and 0.6 g of the toner were added into the plastic bottle. The amount of charge of the toner at a T/C of 9% by mass (T/C 9% charge amount) was measured according to the same method as that for measurement of the toner with the T/C 3% charge amount in all aspects other than that 10.0 g of the carrier and 0.9 g of the toner were added into the plastic bottle, From the measured amounts of charge, a charge gradient (evaluation value) was calculated using a calculation formula “(charge gradient)={[(T/C 3% charge amount)−(T/C 9% charge amount)]/6}/(T/C 6% charge amount)”. The charge gradient indicates the amount of variation in amount of charge of the toner against in-developer toner concentration change. The charge gradient is affected by the absolute value of the amount of charge. Therefore, correction is added by dividing the T/C 6% charge amount in the above calculation formula, A smaller charge gradient indicates less variation in amount of charge of the toner even upon in-developer toner concentration change. Evaluation of charge stability against in-developer toner concentration change was evaluated according to the following criteria.

### (Criteria of Charge Stability)

Good: charge gradient of less than 0.90
Poor (NG): charge gradient of at least 0.90

TABLE 2

| | | | | | Toner |
|---|---|---|---|---|---|
| | Initial | Replenishment | Charge | | scattering |
| | developer | developer | stability | Fogging | (initial) |
| Example 1 | A1 | A1 | 0.71 | 0.002 | 0.061 |
| Example 2 | A2 | A2 | 0.71 | 0.001 | 0.078 |
| Example 3 | A3 | A3 | 0.72 | 0.004 | 0.082 |
| Comparative | B1 | B1 | 0.70 | 0.001 | 0.747 |
| Example 1 | | | | | (NG) |
| Comparative | B2 | B2 | 0.70 | 0.001 | 0.105 |
| Example 2 | | | | | (NG) |
| Comparative | B3 | B3 | 0.73 | 0.006 | 0.112 |
| Example 3 | | | | (NG) | (NG) |
| Example 4 | A4 | A4 | 0.70 | 0.001 | 0.079 |
| Example 5 | A5 | A5 | 0.72 | 0.002 | 0.075 |
| Example 6 | A6 | A6 | 0.74 | 0.003 | 0.089 |
| Example 7 | A7 | A7 | 0.78 | 0.004 | 0.098 |
| Comparative | B4 | B4 | 0.70 | 0.001 | 0.103 |
| Example 4 | | | | | (NG) |
| Comparative | B5 | B5 | 0.85 | 0.005 | 0.120 |
| Example 5 | | | | (NG) | (NG) |
| Example 8 | A8 | A8 | 0.86 | 0.001 | 0.058 |
| Example 9 | A9 | A9 | 0.67 | 0.004 | 0.089 |
| Comparative | B6 | B6 | 0.90 | 0.001 | 0.058 |
| Example 6 | | | (NG) | | |
| Comparative | B7 | B7 | 0.67 | 0.005 | 0.129 |
| Example 7 | | | | (NG) | (NG) |
| Example 10 | A10 | A10 | 0.68 | 0.003 | 0.055 |
| Example 11 | A11 | A11 | 0.78 | 0.004 | 0.097 |
| Comparative | B8 | B8 | 0.67 | 0.005 | 0.054 |
| Example 8 | | | | (NG) | |
| Comparative | B9 | B9 | 0.79 | 0.006 | 0.132 |
| Example 9 | | | | (NG) | (NG) |

As shown in Table 1, the second strontium titanate particles were not attached to the surfaces of the carrier mother particles in the developer (B1). As shown in Table 2, the developer (B1) was rated as poor in evaluation of initial toner scattering.

As shown in Table 1, the content ratio of the second strontium titanate particles in the developer (B2) was less than 0.02 parts by mass relative to 100.00 parts by mass of the carrier mother particles. As shown in Table 2, the developer (B2) was rated as poor in evaluation of initial toner scattering.

As shown in Table 1, the content ratio of the second strontium titanate particles in the developer (B3) was greater than 0.06 parts by mass relative to 100.00 parts by mass of the carrier mother particles. As shown in Table 2, the developer (B3) was rated as poor in both evaluation of fogging and evaluation of initial toner scattering.

As shown in Table 1, the number average primary particle diameter of the second strontium titanate particles was less than 15 nm in the developer (B4). As shown in Table 2, the developer (B4) was rated as poor in evaluation of initial toner scattering.

As shown in Table 1, the number average primary particle diameter of the second strontium titanate particles was greater than 85 nm in the developer (B5). As shown in Table 2, the developer (B5) was rated as poor in both evaluation of fogging and evaluation of initial toner scattering.

As shown in Table 1, the content ratio of the barium titanate particles was less than 2 parts by mass relative to 100 parts by mass of the coating resin in the developer (B6). As shown in Table 2, the developer (B6) was rated as poor in evaluation of charge stability against in-developer toner concentration change.

As shown in Table 1, the content ratio of the barium titanate particles was greater than 47 parts by mass relative to 100 parts by mass of the coating resin in the developer (B7). As shown in Table 2, the developer (B7) was rated as poor in both evaluation of fogging and evaluation of initial toner scattering.

As shown in Table 1, the content ratio of the first strontium titanate particles was less than 0.3 parts by mass relative to 100.0 parts by mass of the toner mother particles in the developer (B8). As shown in Table 2, the developer (B8) was rated as poor in evaluation of fogging.

As shown in Table 1, the content ratio of the first strontium titanate particles was greater than 0.9 parts by mass relative to 100.0 parts by mass of the toner mother particles in the developer (B9). As shown in Table 2, the developer (B9) was rated as poor in both evaluation of fogging and evaluation initial toner scattering.

As shown in Table 1, each of the developers (A1) to (A11) had the following features. That is, the developer included a toner containing toner particles and a first carrier containing first carrier particles. The toner particles each included a toner mother particle and first strontium titanate particles attached to the surface of the toner mother particle. The first strontium titanate particles had a content ratio of at least 0.3 parts by mass and no greater than 0.9 parts by mass to 100.0 parts by mass of the toner mother particles. The first carrier particles each included a carrier mother particle and second strontium titanate particles attached to the surface of the carrier mother particle. The carrier mother particles each included a carrier core and a coat layer covering the surface of the carrier core. The coat layers contained a coating resin and barium titanate particles. The coating resin included silicone resin. The barium titanate particles had a content ratio of at least 2 parts by mass and no greater than 47 parts by mass to 100 parts by mass of the coating resin. The second strontium titanate particles had a number average primary particle diameter of at least 15 nm and no greater than 85 nm. The second strontium titanate particles had a content ratio of at least 0.02 parts by mass and no greater than 0.06 to 100.00 parts by mass of the carrier mother particles. As shown in Table 2, the developers (A1) to (A11) were rated as good or very good in both evaluation of fogging and evaluation of initial toner scattering. Furthermore, each of the developers (A1) to (A11) was rated as good in evaluation of charge stability against in-developer toner concentration change.

From the above, it is determined that the developer of the present disclosure, the developer set including the developer of the present disclosure as an initial developer, and an image forming apparatus including an accommodation section that accommodates the developer of the present disclosure as an initial developer can inhibit toner scattering with less variation in amount of charge of the toner even upon toner concentration change and can form images with less fogging.

[Evaluation 2]

The relationship between presence or absence of the second strontium titanate particles in replenishment developer and the effects in charge stability, fogging, and toner scattering is evaluated according to the following method. Evaluation values for each evaluation are shown below in Table 3.

In evaluation where the second strontium titanate particles were contained in the replenishment developer, the developer (A1) was used as the initial developer and the replenishment developer. The developer (A1) for initial developer use was loaded in the accommodation section of the development device and the developer (A1) for replenishment developer use was loaded in the replenishment section. The toner concentration of the developer (A1) for initial developer use was 8% by mass, and the toner concentration of the developer (A1) for replenishment developer use was 90% by mass.

In evaluation where the second strontium titanate particles were not contained in the replenishment developer, the developer (A1) was used as the initial developer and the developer (B1) was used as the replenishment developer. The developer (B1) had the same features as the developer (A1) in all aspects other than that the second strontium titanate particles were not contained. The developer (A1) for initial developer use was loaded in the accommodation section of the development device and the developer (B1) for replenishment developer use was loaded in the replenishment section. The toner concentration of the developer (A1) for initial developer use was 8% by mass, and the toner concentration of the developer (B1) for replenishment developer use was 90% by mass.

For each of a case where the second strontium titanate particles were contained in the replenishment developer and a case where the second strontium titanate particles were not contained in the replenishment developer, fogging, initial toner scattering, and charge stability were evaluated according to the same methods as those described above in “Evaluation 1”. Note that the developers shown under the column “Initial developer” in Table 3 were evaluated in evaluation of charge stability.

Furthermore, for each of the case where the second strontium titanate particles were contained in the replenishment developer and the case where the second strontium titanate particles were not contained in the replenishment developer, post-printing toner scattering was evaluated according to the following method. Note that the replenishment developer was supplied during the printing and therefore toner scattering after replenishment of the accommodation section with the replenishment developer was evaluated in evaluation of post-printing toner scattering,

<Toner Scattering (Post-Printing)>

The image I was printed on 100,000 sheets of paper in an environment at a temperature of 23° C. and a relative humidity of 65% according to the same method as that described above in <Fogging>. Next, the ceiling (surface denoted by X in FIG. 4) of the development device was cleaned. Next, the image I was printed on additional 1000 sheets of paper in an environment at a temperature of 23° C. and a relative humidity of 5% according to the same method as that described above in <Toner Scattering (Initial)>. Next, the post-printing toner concentration (evaluation value) was measured according to the same method as that described above in <Toner Scattering (Initial)>. Whether or not post-printing toner scattering has been inhibited was evaluated according to the same criteria as those in inhibition of initial toner scattering.

TABLE 3

| | | Replenish- | | | | |
|---|---|---|---|---|---|---|
| | Initial | ment | | | Toner scattering | |
| | deve- | deve- | Charge | | | Post- |
| | loper | loper | stability | Fogging | Initial | printing |
| Example 1 | A1 | A1 | 0.71 | 0.002 | 0.061 | 0.057 |
| Example 12 | A1 | B1 | 0.71 | 0.002 | 0.065 | 0.058 |

The carrier particles in the replenishment developer (developer (A1)) included in the developer set of Example 1 included the second strontium titanate particles in a specific amount on the surfaces of the carrier mother particles thereof. By contrast, the carrier particles in the replenishment developer (developer (B1)) included in the developer set of Example 12 did not include the second strontium titanate particles on the surfaces of the carrier mother particles thereof. Nevertheless, the evaluation results for the developer set of Example 12 were comparable to those for the developer set of Example 1 in each of evaluation of fogging, evaluation of initial and post-printing toner scattering, and evaluation of charge stability against in-developer toner concentration change. It is thought that this is due to some of the second strontium titanate particles of the first carrier particles in the initial developer attaching to the carrier mother particles of the second carrier particles in the replenishment developer.

Furthermore, even when the content ratio of the second strontium titanate particles relative to 100.00 parts by mass of the carrier mother particles in the replenishment developer was reduced from 0.04 parts by mass of the replenishment developer (developer (A1)) to 0.00 parts by mass of the replenishment developer (developer (B1)), evaluation results were equivalent to those obtained when the replenishment developer (developer (A1)) was used. From the above, it is thought that evaluation results equivalent to those obtained when the replenishment developer (developer (A1)) was used can be obtained even when the content ratio of the second strontium titanate particles relative to 100.00 parts by mass of the carrier mother particles was greater than 0.00 parts by mass and no greater than 0.01 parts by mass.

Form the above, it is through that as a result of the second strontium titanate particles being included in the first carrier particles in the initial developer even when the second carrier particles in the replenishment developer substantially include no second strontium titanate particles, toner scattering can be inhibited with less variation in amount of charge of the toner even upon toner concentration change and images with less fogging can be formed. Furthermore, non-use of the second strontium titanate particles in the replenishment developer can reduce manufacturing cost of the developer set.

What is claimed is:

1. A developer comprising:
a toner containing toner particles; and
a first carrier containing first carrier particles, wherein
the toner particles each include a toner mother particle and first strontium titanate particles attached to a surface of the toner mother particle,
the first strontium titanate particles have a content ratio of at least 0.3 parts by mass and no greater than 0.9 parts by mass to 100.0 parts by mass of the toner mother particles,
the first carrier particles each include a carrier mother particle and second strontium titanate particles attached to a surface of the carrier mother particle,
the carrier mother particles each include a carrier core and a coat layer covering the surface of the carrier core,
the coat layers contain a coating resin and barium titanate particles,
the coating resin includes silicone resin,
the barium titanate particles have a content ratio of at least 2 parts by mass and no greater than 47 parts by mass to 100 parts by mass of the coating resin,
the second strontium titanate particles have a number average primary particle diameter of at least 15 nm and no greater than 85 nm, and
the second strontium titanate particles have a content ratio of at least 0.02 parts by mass and no greater than 0.06 parts by mass to 100.00 parts by mass of the carrier mother particles.

2. The developer according to claim 1, wherein
the coat layers further contain carbon black particles.

3. The developer according to claim 1, wherein
the first strontium titanate particles have a number average primary particle diameter of at least 15 nm and no greater than 85 nm.

4. A developer set comprising:
an initial developer; and
a replenishment developer, wherein
the initial developer is the developer according to claim 1.

5. The developer set according to claim 4, wherein
the replenishment developer includes the toner containing the toner particles and a second carrier containing second carrier particles,
the second carrier particles each include the carrier mother particle, and
the second carrier particles substantially include no second strontium titanate particles on a surface of the carrier mother particle.

6. An image forming apparatus comprising:
a developer; and
a development device that develops an electrostatic latent image with the developer, wherein
the developer includes an initial developer,
the development device includes an accommodation section that accommodates the initial developer, and
the initial developer is the developer according to claim 1.

7. The image forming apparatus according to claim 6, wherein
the developer further includes a replenishment developer,
the development device further includes a replenishment section that replenishes the accommodation section with the replenishment developer,
the replenishment developer includes the toner containing the toner particles and a second carrier containing second carrier particles,
the second carrier particles each include the carrier mother particle, and
the second carrier particles substantially include no second strontium titanate particles on a surface of the second carrier mother particle.
